(19) United States
(12) Patent Application Publication
(10) Pub. No.: US 2012/0015723 A1
(43) Pub. Date: Jan. 19, 2012

(54) HUMAN-MACHINE INTERACTION SYSTEM

(75) Inventor: Yen-Hung Lai, Taipei (TW)

(73) Assignee: COMPAL COMMUNICATION, INC., Taipei (TW)

(21) Appl. No.: 13/086,394

(22) Filed: Apr. 14, 2011

(30) Foreign Application Priority Data
Jul. 16, 2010 (CN) CN201010233676.7

(51) Int. Cl. G06F 17/00

(52) U.S. Cl. 463/31

(57) ABSTRACT

A human-machine interaction system is provided for executing a script. The human-machine interaction system includes a display device, a mechanical device, a sensing module and a processing module. The display device is used for showing an interactive image within an interactive zone. The mechanical device is movable within the interactive zone. The sensing module is used for receiving an input action within the interactive zone. The processing module is electrically connected with the display device, the sensing module and the mechanical device. According to the input action and the script, the processing module controls operations of the mechanical device and controls the display device to update the interactive image. By the inventive human-machine interaction system, the physical and virtual interactive elements can be integrated to provide the user with a new operating mode.

### PRIORITY CLAIM

The present application claims priority to China Patent Application No. CN201010233676.7, filed on Jul. 16, 2010.

### FIELD OF THE INVENTION

The present invention relates to a human-machine interaction system, and more particularly to a human-machine interaction system integrating physical and virtual interactive elements.

### BACKGROUND OF THE INVENTION

With increasing development of science and technology, intelligent toys are now rapidly gaining in popularity. For example, an interactive doll (e.g. a robot or a mechanical animal) which interacts with the user has become one of the most favorite toys among different age groups.

The interactive doll has capability of communicating and interacting with the user. For example, by cuddling or patting the interactive doll, the interactive doll can be directly interacted with the user. When the sensor of the interactive doll detects the cuddling or patting action, the interactive doll will respond with a specified action or a specified sound.

However, since the interactive way of playing with the interactive doll is usually monotonous, the user may usually feel bored after a long time.

### SUMMARY OF THE INVENTION

It is an object of the present invention to provide a human-machine interaction system for executing a script, in which an interactive image is created by a display technology and integrated with the interactive doll. Consequently, the interactive image may be designed to comply with different scenarios so as to meet the requirements of the user.

It is another object of the present invention to provide a human-machine interaction system capable of integrating the physically mechanical device and virtually interactive image so as to provide a new operating mode and enhance the interactive efficacy.

In accordance with an aspect of the present invention, there is provided a human-machine interaction system for executing a script. The human-machine interaction system includes a display device, a mechanical device, a sensing module and a processing module. The display device is used for showing an interactive image within an interactive zone. The mechanical device is movable within the interactive zone. The sensing module is used for receiving an input action within the interactive zone. The processing module is electrically connected with the display device, the sensing module and the mechanical device. According to the input action and the script, the processing module controls operations of the mechanical device and controls the display device to update the interactive image.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a human-machine interaction system according to a first embodiment of the present invention;

FIG. 2 schematically illustrates an application example of the human-machine interaction system according to the first embodiment of the present invention;

FIG. 3 schematically illustrates an application example of a human-machine interaction system according to a second embodiment of the present invention;

FIG. 4 is a schematic functional block diagram illustrating a human-machine interaction system according to a third embodiment of the present invention; and

FIG. 5 schematically illustrates an application example of the human-machine interaction system according to the third embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

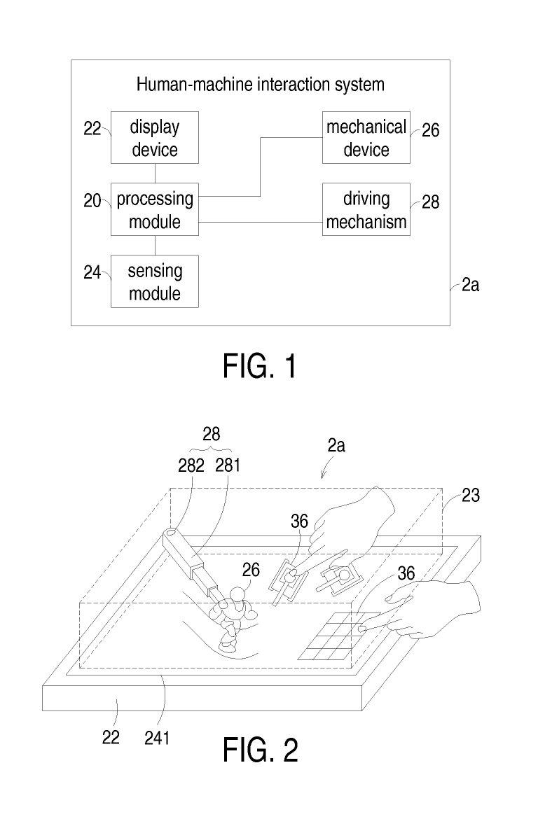

FIG. 1 is a schematic functional block diagram illustrating a human-machine interaction system according to a first embodiment of the present invention. FIG. 2 schematically illustrates an application example of the human-machine interaction system according to the first embodiment of the present invention. As shown in FIGS. 1 and 2, the human-machine interaction system 2a comprises a processing module 20, a display device 22, a sensing module 24, a mechanical device 26 and a driving mechanism 28.

The processing module 20 is electrically connected with the display device 22, the sensing module 24, the mechanical device 26 and the driving mechanism 28. The human-machine interaction system 2a has a predetermined interactive zone 23. In a case that the user's hand is located within the interactive zone 23, the user may interact with the mechanical device 26 through the sensing module 24. Moreover, the human-machine interaction system 2a is configured to execute a script. For example, the script contains program codes of a game, an interactive electronic book or other application program.

In this embodiment, the display device 22 is a flat panel display. The display device 22 is electrically connected with the processing module 20. The displaying surface of the display device 22 abuts against a border of the interactive zone 23 to display a two-dimensional interactive image 36 on the interactive zone 23. In some other embodiments, the display device 22 is a projector, which is disposed at another position for projecting the interactive image onto the interactive zone 23. In some other embodiments, the display device 22 is any display device capable of producing a stereoscopic vision effect within the range of the interactive zone 23. In some other embodiments, the display device 22 is a holographic display device capable of directly displaying a stereoscopic image.

The mechanical device 26 is movable within the interactive zone 23. That is, the mechanical device 26 can be moved within the interactive zone 23 rather than fixed in a specified position. By the driving mechanism 28, the mechanical device 26 is driven to move within the interactive zone 23. The driving mechanism 28 is electrically connected with the processing module 20. Moreover, the driving mechanism 28 comprises a retractable push rod 281 and a shaft 282. The shaft 282 is pivotally fixed at an edge of the interactive zone 23. A first end of the retractable push rod 281 is connected with the shaft 282. A second end of the retractable push rod 281 is coupled with the mechanical device 26. In response to a rotating action of the shaft 282 and the linear moving action of the retractable push rod 281, the mechanical device 26 can be moved to a specified position of the interactive zone 23.

Moreover, the shape of the mechanical device 26 may be varied according to the practical requirements. Depending on the shape of mechanical device 26, the mechanical components are varied. For example, as shown in FIG. 2, the mechanical device 26 is a robot. The robot has some mechanical components for simulating various actions. In some embodiments, the mechanical device 26 has another shape such as an animal or a vehicle. Moreover, the mechanical device 26 is electrically connected with the processing module 20 through a built-in circuitry of the driving mechanism 28 so as to receive commands from the processing module 20.

The sensing module 24 is configured to receive an input action of a user within the interactive zone 23. According to the input action and the script, the processing module 20 controls operations of the mechanical device 26 and updates the interactive image 36 shown on the display device 22. In this embodiment, the sensing module 24 is a touch panel 241, which is installed on the display device 22. In response to an input action of the user on the touch panel 241, for example the action of clicking and dragging the interactive image 36 shown on the display device 22, a corresponding touching signal is received by the touch panel 241 and then transmitted to the processing module 20.

Then, the touching signal is analyzed by the processing module 20. According to the touching signal and the script, a next action of the human-machine interaction system 2a is determined by the processing module 20. For example, the processing module 20 may control the driving mechanism 28 to move the mechanical device 26 within the interactive zone 23, directly control movement of the mechanical device 26 or control the display device 22 to update the interactive image 36.

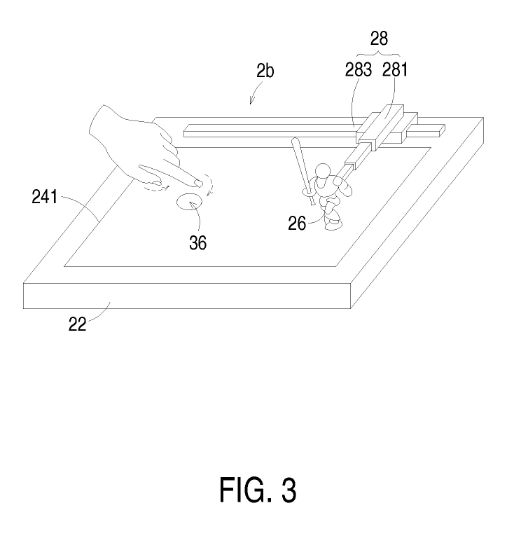

FIG. 3 schematically illustrates an application example of a human-machine interaction system according to a second embodiment of the present invention. In the human-machine interaction system 2b, the driving mechanism 28 comprises a track 283 and a retractable push rod 281. The retractable push rod 281 is installed on the track 283 and movable along the track 283. In addition, the retractable push rod 281 may be stretched out or drawn back in a direction perpendicular to the track 283. A first end of the retractable push rod 281 is connected with the track 283. A second end of the retractable push rod 281 is coupled with the mechanical device 26. In such way, the mechanical device 26 can be moved to a specified position of the interactive zone 23 by the driving mechanism 28.

For example, the human-machine interaction system 2b may be used to execute a ball game or a hitting game. In this embodiment, the mechanical device 26 is a robot holding a bat. During an operation of the human-machine interaction system 2b, the user's finger may touch the touch panel 241 overlying the display device 22 and a user's gesture on the interactive image 36 may be made to control the motion of the interactive image 36. After the user's gesture is detected by the touch panel 241, the touch panel 241 issues a touching signal to the processing module 20. Then, the touching signal is analyzed by the processing module 20. According to the user's gesture and the script, the processing module 20 will control operations of the mechanical device 26 and control the display device 22 to update the interactive image 36.

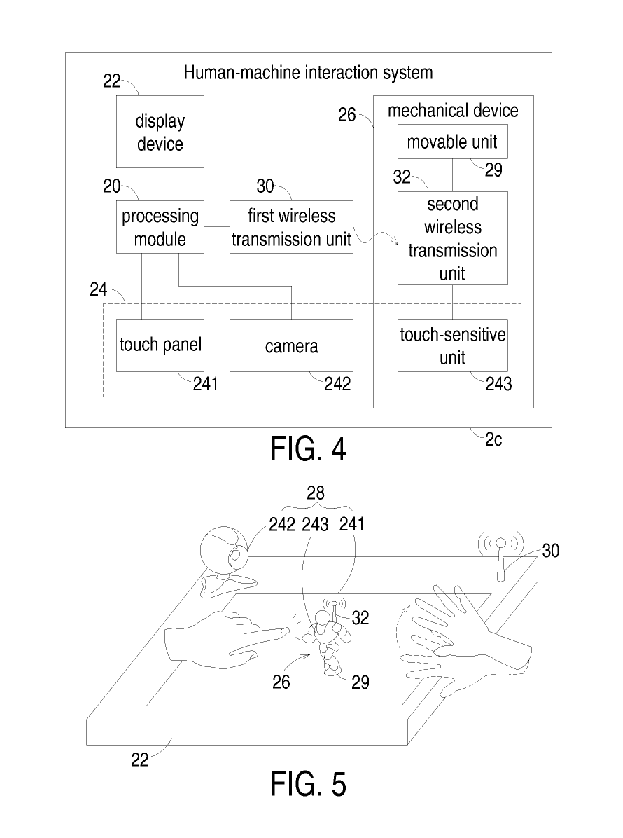

FIG. 4 is a schematic functional block diagram illustrating a human-machine interaction system according to a third embodiment of the present invention. FIG. 5 schematically illustrates an application example of the human-machine interaction system according to the third embodiment of the present invention. As shown in FIGS. 4 and 5, the human-machine interaction system 2c comprises a processing module 20, a display device 22, a sensing module 24, a mechanical device 26, a first wireless transmission unit 30 and a second wireless transmission unit 32.

The first wireless transmission unit 30 and the second wireless transmission unit 32 are in communication with each other to receive and transmit data according to a wireless transmission technology. In this embodiment, the first wireless transmission unit 30 is disposed on the display device 22 and electrically connected with the processing module 20, but it is not limited thereto. The second wireless transmission unit 32 is disposed on the mechanical device 26.

The sensing module 24 comprises a touch panel 241, a camera 242 and a touch-sensitive unit 243. The functions of the touch panel 241 are similar to those of the above embodiments, and are not redundantly described herein. The camera 242 is used for shooting the mechanical device 26 and the user's gesture, thereby acquiring a digital image. The digital image is transmitted to the processing module 20. Consequently, the user's gesture contained in the digital image is analyzed by the processing unit 20.

The touch-sensitive unit 243 is disposed on the mechanical device 26 and electrically connected with the second wireless transmission unit 32. In addition, the touch-sensitive unit 243 is used for sensing a touching action of a user. In response to the touching action on the touch-sensitive unit 243, the touch-sensitive unit 243 issues a sensing signal. The sensing signal is transmitted to the processing module 20 through the first wireless transmission unit 30 and the second wireless transmission unit 32.

The mechanical device 26 comprises a movable unit 29. In this embodiment, the movable unit 29 is a bipedal walking system. Alternatively, the movable unit 29 is a wheel-moving system or a caterpillar-walking system. Moreover, the touch-sensitive unit 243 and the second wireless transmission unit 32 are disposed on the mechanical device 26. The mechanical device 26 is electrically connected with the touch-sensitive unit 243 and the movable unit 29.

The processing module 20 is electrically connected with the display device 22, the touch panel 241, the camera 242 and the first wireless transmission unit 30. According to the script, the user's gesture and the touching action of the user, the processing module 20 will control operations of the mechanical device 26 and control the display device 22 to update the interactive image 36. In other words, the movable unit 29 is controlled by the processing module 20 through the first wireless transmission unit 30 and the second wireless transmission unit 32, so that the mechanical device 26 is moved within the interactive zone.

From the above description, since the human-machine interaction system integrates the physically mechanical device and virtually interactive image, a new operating mode can be provided and the interactive efficacy is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A human-machine interaction system for executing a script, said human-machine interaction system comprising:
a display device for showing an interactive image within an interactive zone;
a mechanical device movable within said interactive zone;
a sensing module for receiving an input action within said interactive zone; and
a processing module electrically connected with said display device, said sensing module and said mechanical device, wherein according to said input action and said script, said processing module controls operations of said mechanical device and controls said display device to update said interactive image.

2. The human-machine interaction system according to claim 1 wherein said sensing module comprises a touch panel, which is disposed on said display device.

3. The human-machine interaction system according to claim 1 wherein according to a user's gesture detected by said sensing module and said script, said processing module controls operations of said mechanical device and controls said display device to update said interactive image.

4. The human-machine interaction system according to claim 1 wherein said sensing module comprises a camera.

5. The human-machine interaction system according to claim 4 wherein according to a user's gesture detected by said sensing module and said script, said processing module controls operations of said mechanical device and controls said display device to update said interactive image.

6. The human-machine interaction system according to claim 1 wherein said sensing module comprises a touch-sensitive unit, which is disposed on said mechanical device for sensing a touching action of a user, wherein according to said touching action and said script, said processing module controls operations of said mechanical device.

7. The human-machine interaction system according to claim 1 further comprising a driving mechanism, which is electrically connected with said processing module and comprises a retractable push rod, wherein an end of said retractable push rod is connected with said mechanical device, wherein according to said input action and said script, said processing module controls said driving mechanism to move said mechanical device to a specified position of said interactive zone.

8. The human-machine interaction system according to claim 1 wherein a displaying surface of said display device abuts against a border of said interactive zone to show said interactive image on said interactive zone in a two-dimensional or stereoscopic manner.

9. The human-machine interaction system according to claim 1 wherein said mechanical device further comprises a movable unit, wherein said movable unit is moved under control of said processing module.

10. The human-machine interaction system according to claim 9 further comprising:
a first wireless transmission unit electrically connected with said processing module; and
a second wireless transmission unit disposed on said mechanical device and electrically connected with said movable unit, wherein said movable unit is controlled by said processing module through said first wireless transmission unit and said second wireless transmission unit.

11. The human-machine interaction system according to claim 1 wherein said script contains program codes of a game, an interactive electronic book or other application program.
